(19) United States
(12) Patent Application Publication
(10) Pub. No.: US 2019/0266687 A1
(43) Pub. Date: Aug. 29, 2019

(54) MANAGEMENNT OF PUBLIC FUNDS FOR MAINTENANCE AND REPAIR OF INFRASTRUCTURE

(71) Applicant: Robert L. Klopfenstein, Saint Augustine, FL (US)

(72) Inventor: Robert L. Klopfenstein, Saint Augustine, FL (US)

(21) Appl. No.: 15/907,754

(22) Filed: Feb. 28, 2018

(51) Int. Cl. G06Q 50/26; G06Q 10/00; G06Q 10/06; G06Q 20/24

(52) U.S. Cl. CPC G06Q 50/26; G06Q 20/24; G06Q 10/06313; G06Q 10/20

(57) ABSTRACT

An infrastructure funding system permits budgeting the cost of maintaining and repairing an asset infrastructure system over its lifetime with fixed periodic costs over the lifetime of the system. This is accomplished by assessing the current lifetime and asset maintenance value of the system and establishing a total cost estimate for maintaining and repairing the system. The burden of maintaining and repairing the system is then transferred to a vendor. The vendor then collects the total cost estimate in increments over the lifetime of the system and assumes full responsibility for the maintenance and repair of the system.

### BACKGROUND OF THE INVENTION

### Field of the Invention

This invention is directed to a method for managing funds and controlling future deficits generally related to infrastructure support and maintenance.

### Discussion of the State of the Art

Every family, community and business needs infrastructure to thrive. America's infrastructure is aging and increasingly is in a state of serious disrepair. The American Society of Civil Engineers periodically analyzes America's infrastructure and their most recent assessment in 2017 gave it a letter grade of D+. They estimate an investment of $4.59 trillion is needed by the year 2027. Specific to the nation's wastewater and stormwater systems it is estimated that an investment totaling $271 billion will be required over the next 25 years.

There are approximately 800,000 miles of public sewer mains and more than 26 million sewer manholes in the United States. Many of these were installed shortly after World War II, meaning they are now approaching the end of their useful life.

Additionally, there are roughly 15,000 wastewater treatment facilities, many in poor condition with aging pipes and inadequate capacity leading to the discharge of an estimated 900 billion gallons of untreated sewage each year. 98% of public owned sewer systems are municipally owned. The nation's 51,000 community water systems deliver drinking water via one million miles of pipes across the country. Many of these pipes were laid in the early to mid-20^{th} century with a life span of 75 to 100 years. At the current rate of replacement it will take an estimated 200 years to replace the system—nearly double the useful life of the pipes.

State and local governments are simply unable to keep up with the infrastructure need. The Congressional Budget Office, EPA, and other groups have estimated that nearly $300 billion is required to address the nation's sewage collection and treatment needs over 25 years to keep surface waters safe and clean. This is the current level of investment required by all levels of government.

Currently companies and entities are hired by the government entity controlling the infrastructure (typically a municipality of local government) to perform infrastructure protection and rehabilitation work for fees which consist of labor, material and profit. The municipality is limited to how much work it can have done based upon the amount of budgeted money it has available and allocated to that infrastructure work. This budget is not based on perceived or calculated need but is a pay as required system in most cases. This often results in a deficit when repairs exceed budgeted funds or the work is delayed until a future budget cycle is approved, leaving many systems in a constant state of disrepair.

### SUMMARY OF THE INVENTION

The invention is directed to a system that provides the required level of protection and rehabilitation work for a “rental” charge for a set number of years and would assume all responsibility for the performance of the protection and rehabilitation work and any subsequent repairs required during the time frame.

This effectively moves the capital cost from the municipality to the private sector and allows a large volume of additional work to be completed without additional public taxpayer funding. It also provides predictability for the municipality, assuring more accurate budgeting and realistic assessment of future costs.

Specifically, the municipality or a third-party supplier would provide an initial assessment of the structures to be maintained over a fixed period, say for example 20 years. Based on history, an overall cost can be projected, and a fixed periodic fee can be ascertained. The municipality would then be able to budget this fixed amount, eliminating surprises and budget overruns. The third-party supplier would be responsible for managing the funds and for making all repairs and rehabilitation out of the funded budget. The value of this system is it flattens out the annual budget, with the supplier being responsible for accurate estimates and the requirement to live within the budget.

### BRIEF DESCRIPTION OF THE DRAWING

FIG. 1 is a block diagram showing the system process.

### DETAILED DESCRIPTION OF THE PREFERRED EMBODIMENT

The subject invention is directed to an infrastructure funding system for budgeting the cost of maintaining and repairing an asset infrastructure system over its lifetime with fixed periodic costs over the lifetime of the system. This is accomplished by assessing the current lifetime and asset maintenance value of the system and establishing a total cost estimate for maintaining and repairing the system. The burden of maintaining and repairing the system is then passed to a vendor. The vendor then collects the total cost estimate in increments over the lifetime of the system and assumes full responsibility for the maintenance and repair of the system.

The operation of the system is best demonstrated by an example, as follows:

Assume a municipality budgets $50,000 annually to spend on manhole rehabilitation. At a current price of $200 per vertical foot the $50,000 would cover 25 manholes that are 10 feet deep.

If the municipality has 1,000 manholes in its systems, at a rate of 25 manholes rehabbed per year, it would take 40 years to complete.

Assuming a 20-year life for manholes, this approach assures deficit budgeting during at least the second half of the 20-year life.

Using the system of the subject invention, the municipality budgets the same $50,000 annually.

At a proposed rental price of $20 per month per manhole for a 20-year contract period, the $50,000 would be enough to complete roughly 200 manholes per year and the 1,000 manholes would be completed in 5 years instead of 40. Thus, the deficit budgeting model would be eliminated. This is because the immediate needs are fully covered by current funding and the long-term needs are covered by excess early funding providing funds for future work without seeking additional tax payments or other payment vehicles to cover unbudgeted high maintenance older manholes.

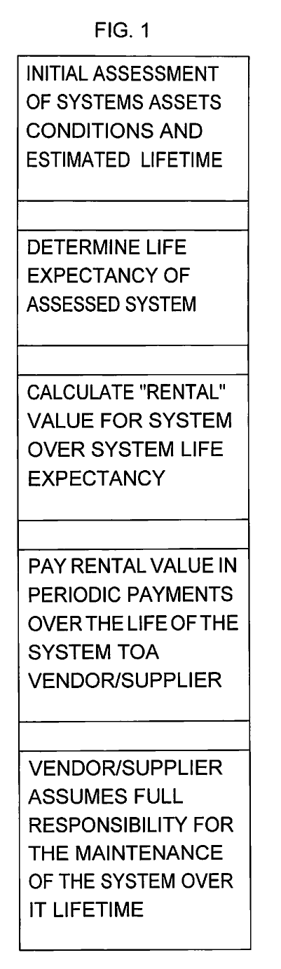

In essence, and as shown in FIG. 1, the vendor/supplier to the municipality assumes pseudo ownership of the system and leases it back to the municipality. However actual ownership of the asset always remains with the municipality.

The municipality has a fixed and predictable costs for the system and the vendor has a steady stream of predictable income. Initially, as shown in box 1, there would be an initial assessment of the assets to be “leased”. The lease would have a duration equal to the expected life expectancy of the system, as shown in box 2. The will permit calculation of a fair lease price as shown in box 3. This lease price would be paid periodically, typically monthly or annually, as shown box 4. The vendor assumes full responsibility for the maintenance, repair and upkeep of the system as shown in box 5.

New assets can be added by following the same system and establishing the lifetime cycle for such assets.

While certain features and embodiments of the invention are shown in detail herein, it should be understood that the invention includes all modifications and enhancements within the scope of the following claims.

What is claimed is:

1. An infrastructure funding system for budgeting the cost of maintaining and repairing a publicly owned asset infrastructure system over its lifetime with fixed periodic costs over the lifetime of the system, comprising:
a. Assessing the current lifetime and asset maintenance value of the system;
b. Establishing a total cost estimate for maintaining and repairing the system;
c. Transferring the burden of maintaining and repairing the system to a vendor;
d. The vendor collecting the total cost estimate in increments over the lifetime of the system; and
e. The vendor assuming full responsibility for maintaining and repairing the system for the agreed total cost estimate in accordance with the established incremental payments.

2. The infrastructure funding system of claim 1 wherein the incremental payments are made monthly over the lifetime of the system.

3. The infrastructure funding system of claim 1, wherein the incremental payments are made annually over the lifetime of the system.
